(19) United States
(12) Patent Application Publication
(10) Pub. No.: US 2008/0269076 A1
(43) Pub. Date: Oct. 30, 2008

(54) Multiple Capillary Device and Method for Synthesis and Dispensing

(75) Inventor: Sergey V. Ermakov, Hayward, CA (US)

Correspondence Address: KILYK & BOWERSOX, P.L.L.C., 3925 CHAIN BRIDGE ROAD, SUITE D401, FAIRFAX, VA, 22030, US

(73) Assignee: Applera Corporation, Foster City, CA (US)

(21) Appl. No.: 11/919,965

(22) PCT Filed: May 4, 2006
(86) PCT No.: PCT/US06/17187

§ 371 Date: Jun. 27, 2008

Related U.S. Application Data
(60) Provisional application No. 60/678,448, filed on May 6, 2005.

(51) Int. Cl. C40B 50/18; C40B 60/14

(52) U.S. Cl. 506/32; 506/40

(57) ABSTRACT

A system and method for synthesizing a peptide, a nucleic acid sequence, an oligonucleotide, a DNA sequence, an RNA sequence, or the like, inside an array of capillary tubes, is provided. The system can comprise an array of capillary tubes. Each of the capillary tubes in the array of capillary tubes can comprise a first end, a second end, an inner wall, and a sequence linker bonded to the inner wall. The system can comprise a pressure control source that can be in fluid communication with each of the first ends of the array of capillary tubes. The system can comprise a reagent container support, wherein the second end of each of the capillary tubes can be adapted to move towards and/or away from the reagent container support.

### CROSS REFERENCE TO RELATED APPLICATION

The present application claims a priority benefit from earlier filed U.S. Provisional Application No. 60/678,448, filed May 6, 2005, which is herein incorporated by reference in its entirety.

### FIELD

The teachings herein relate to synthesis, for example, oligonucleotide synthesis, by attaching nucleotide derivatives by means of a linker arm to an inner surface of a capillary.

### INTRODUCTION

A synthesis process can begin with attachment of a nucleotide derivative at its 3′-terminus by means of a linker arm to a solid support, for example, a silica gel or a column of borosilicate glass beads. However, such a process can require the step of transferring synthesized oligonucleotides into capillary tubes for analysis.

### SUMMARY

In various embodiments, a system is provided that can comprise an array of capillary tubes. Each capillary tube in the array of capillary tubes can comprise a first end, a second end, an inner wall, and a linker bonded to the inner wall. The system can comprise a pressure control source in fluid communication with each of the first ends. The system can comprise a reagent container support, wherein the second end of each of the capillary tubes can individually move toward and/or away from the reagent container support.

In various embodiments, a system is provided that can comprise an array of capillary tubes. Each of the capillary tubes in the array of capillary tubes can comprise a first end, a second end, and an inner wall. The system can comprise a pressure control source in fluid communication with each of the first ends. The system can comprise a reagent container support that can comprise a rotating platen adapted to hold a plurality of reagent containers. In the system of the present teachings, the second end of each capillary tube can be adapted to individually move toward and/or away from the reagent container support.

In various embodiments, a method is provided for synthesizing oligonucleotides. The method can comprise providing an array of capillary tubes. Each of the capillary tubes can comprise a first end, a second end, an inner wall, and at least one linker bonded to the inner wall. In some exemplary embodiments, the linker can comprise a protector. The method can comprise connecting a pressure control source to the first ends, wherein the pressure control source is capable of providing a pressure differential to each of the capillary tubes. The method can comprise moving one or more of the second ends into communication with a first reagent. According to the present teachings, the method can comprise drawing the first reagent through one or more of the second ends into the one or more respective capillary tubes. The first reagent can react with a linker in one or more of the respective array of capillary tubes to form a first activated sequence. The method can comprise removing the excess first reagent from one or more of the respective array of capillary tubes. In various embodiments, the method of the present teachings can comprise moving one or more of the second ends into communication with a second reagent. The second reagent can be drawn through one or more of the second ends and into one or more of the respective array of capillary tubes. The method can comprise reacting the second reagent with the first activated sequence to form a first sequence.

Additional features and advantages of various embodiments will be set forth, in part, in the description that follows, and, in part, will be apparent from the description, or can be learned by the practice of various embodiments. Other advantages of the various embodiments will be realized and attained by means of the elements and combinations exemplified in the application. These and other features of the present teachings are set forth herein.

### DRAWINGS

The skilled artisan will understand that the drawings, described below, are for illustration purposes only. The drawings are not intended to limit the scope of the present teachings in any way.

FIG. 1 is a perspective view of a system, according to various embodiments;

FIG. 2 is a perspective view illustrating a relationship between a first interface, a second interface (capillary array head/template), and an array of capillary tubes;

FIG. 3 is an enlarged side plan view of a second interface and second ends of capillary tubes;

FIG. 4 is an enlarged side cross-sectional view of a capillary tube comprising an activated linker on an inner surface of the capillary tube, according to various embodiments;

FIG. 5 is an enlarged side cross-sectional view of a capillary tube comprising a linker bonded with a protected guanine on an inner surface, according to various embodiments;

FIG. 6 is an enlarged side cross-sectional view of a capillary tube comprising a linker bonded with an activated guanine on an inner surface, according to various embodiments;

FIG. 7 is an enlarged side cross-sectional view of a capillary tube comprising a linker bonded with a guanine and a protected thymine on an inner surface, according to various embodiments;

FIG. 8 is a process diagram for adding nucleotides to a subset of an array of capillary tubes, according to various embodiments;

FIG. 9 is a process diagram for adding nucleotides to a subset of an array of capillary tubes, according to various embodiments;

FIG. 10 is a side cross-sectional view of a system that is adding nucleotides to a subset of capillary tubes, according to various embodiments; and

FIG. 11 is a side cross-sectional view of a system that is adding nucleotides to a subset of capillary tubes, according to various embodiments.

It is to be understood that both the foregoing general description and the following detailed description are exemplary and explanatory only and are intended to provide a further explanation of the various embodiments of the present teachings.

### DESCRIPTION OF VARIOUS EMBODIMENTS

According to various embodiments, a system is provided that can comprise an array of capillary tubes. Each capillary tube in the array of capillary tubes can comprise a first end, a second end, an inner wall, and a sequence linker bonded to the inner wall. The system can comprise a pressure control source in fluid communication with each of the first ends. The system can comprise a reagent container support, wherein the second end of each of the array of capillary tubes can be adapted to move individually and/or together toward and/or away from the reagent container support.

According to various embodiments, the array of capillary tubes of the present teachings can be made of fused silica that can comprise a coating, such as, for example, a polyimide coating. The array of capillary tubes can comprise commercially available capillary tubes. A capillary tube can comprise a sufficient inner surface area to provide an adequate synthesis scale, a sufficient surface area to allow a reagent to easily flow through the capillary tube, and an inner surface that can allow a sequence linker to bond to its inner wall surface. An exemplary capillary tube can have an inner diameter of from about 20 μm to about 130 μm. For example, the inner diameter of the capillary tubes of the present teaching can be from about 25 μm to about 100 μm or from about 50 μm to about 100 μm. The outer diameter of the capillary tubes of the present teaching can be from about 10 μm to about 200 μm, such as, for example, from about 160 μm to about 170 μm. Such capillary tubes are commercially available from Polymicro Tech.

According to various embodiments, a scale of the synthesis can be determined by a length, diameter, and count of the array of capillary tubes. In other embodiments, a volume of the reagent can affect the scale of the synthesis.

According to various embodiments, the array of capillary tubes can comprise a linker or a sequence linker. The array of capillary tubes can be treated to form chemically reactive surface groups, for example, carboxyl, hydroxyl, or amine groups on an inner wall portion of a capillary tube. The chemically reactive surface groups, a linker and/or a chemical group, can serve as a chemical platform for solid-phase synthesis of library compounds on the inner wall portions of the tubes. In some exemplary embodiments, the linker can comprise a nucleotide linker and/or an amino acid linker. The linker can be chemisorbed or physisorbed to the inner of the capillary tubes. Methods for derivatizing glass surfaces for various types of solid-phase synthesis are described, for example, in U.S. Pat. Nos. 5,436,327; 5,142,047; 5,137,765; and 4,992,383, all of which are incorporated by reference herein in their entirety. In the event that one or more of the incorporated literature and/or similar materials differ from or contradict this application, including but not limited to defined terms, term usage, described techniques, or the like, this application controls.

The capillary tubes of the present teaching can have a length sufficient to be connected to a pressure control source at one end and to reach a loading tray having a reagent or at least one container having a reagent, or a waste reservoir at the other end. The length of the array of capillary tubes can be, for example, from about 5 cm to about 500 cm, for example, about 20 cm, about 40 cm, or about 100 cm.

The pressure control source can be a pressure control block. The pressure control source can be any pressure controller that can provide a positive and/or negative pressure at a capillary tube end. The pressure control device can provide an excess pressure or a vacuum at an end of each capillary tube of the array of capillary tubes. The pressure control source can comprise an air tight compartment that can control liquid/gas flow into and out of the array of capillary tubes with the necessary pressure/vacuum source. An exemplary pressure control source can be a vacuum pump (having a cylinder or a piston) and/or a valve.

According to various embodiments, the system can comprise a reagent container support. The reagent container support can be in any shape or form capable of supporting at least one reagent container, loading tray, and/or a waste reservoir. The reagent container support can comprise a table. In other embodiments, the reagent container support can comprise a rotating platen. The reagent container support can be adapted to support a plurality of reagent plates. The reagent container(s), the loading tray(s), and/or the waste reservoir(s) can comprise a container, a well in a multi-well plate, at least one multi-well plate, and/or each can be disposed on the reagent container support. The multi-well plate can comprise a plurality of wells. The reagent container(s), the loading tray(s), and/or the waste reservoir(s) each can be in fluid communication with one end of one or more of the array of capillary tubes.

According to various embodiments, the container can comprise a microfluidic device or a microtiter plate. The microfluidic device/microtiter plate can be located proximate the second ends of the array of the capillary tubes. The microfluidic device/microtiter plate of the present teaching can comprise 4, 12, 24, 48, 96, 384, 768, 1536, 3072, or 6144 more wells, and can contain up to and including 4, 12, 24, 48, 96, 384, 768, 1536, 3072, or 6144 more individual reagents/solutions, respectively. The microfluidic device/microtiter plate of the present teaching can be one that is commercially available. Each well in the microfluidic device can correspond to a particular capillary tube and well of the loading plate.

According to various embodiments, the system can comprise at least one dispensing unit that can transport reagents or a washing solution from one or more of the containers comprising a reagent or a washing solution to one or more loading trays or waste reservoir. The dispensing unit can be programmed to be capable of selectively filling each of the individual wells in one or more of the loading trays. The dispensing unit is commercially available.

According to various embodiments, the system can comprise a first interface arranged to hold the array of capillary tubes operatively within the pressure control source. The first interface can connect the array of capillary tubes to the pressure control source. The first interface can be a universal interface so that different arrays of capillary tubes can be easily plugged in the pressure control source.

According to various embodiments, the system can comprise a second interface that can be capable of holding the ends of the capillary tubes in the microfluidic device. The second interface can comprise a capillary array head or template. The shape and size of the second interface can be determined by the nature of the microfluidic device into which the dispensing takes place. The second interface can be capable of holding the array of the capillary tubes in a precise pattern by threading the capillary tubes through an array template. An array template can be a structure designed to maintain the capillary tubes in a desired configuration and spacing. The array template can comprise, without limitation, a metal grid or mesh, a rigidly-held fabric mesh, a bundle of “sleeve” tubes having an inner diameter sufficient to admit the fluid delivery capillaries, or a solid block having holes or channels, for example, a perforated aluminum block. The ends of the array of capillary tubes can extend beyond the second interface. The extended end can uptake reagents or solutions from a loading tray or a reagent container. In some embodiments, the array of capillary tubes can extend from about 0.1 cm or more beyond the second interface. For example, the array of capillary tubes can extend from about 0.2 cm to about 1 cm beyond the second interface, for example, about 0.5 cm beyond the second interface. The extended ends of the capillary tubes can be inserted into the individual wells of the microfluidic device/microtiter plate for reagent loading and sample dispersing.

In various embodiments, a method is provided that can comprise providing an array of capillary tubes. Each capillary tube can comprise a first end, a second end, an inner wall, and a linker bonded to the inner wall. The method can comprise connecting a pressure control source to the first ends, wherein the pressure control source can be capable of providing a pressure differential to one or more of the array of capillary tubes. The method can comprise moving one or more of the second ends into communication with a first reagent in a loading tray or a first container. In some embodiments, one or more of the second ends can be brought into communication with the first reagent by a moving arm, such as, for example, a robot arm. According to the present teachings, the method can comprise drawing the first reagent through one or more of the second ends into one or more of the respective array of capillary tubes. The first reagent can react with a linker in one or more of the respective capillary tubes to form a first activated sequence. The method can comprise removing any excess first reagent from one or more of the respective capillary tubes. In some examples, the excess first reagent can be discharged into a waste reservoir. The method of the present teachings can comprise moving one or more of the second ends, for example, by a robot arm, into communication with a second reagent in the loading tray or in a second container. The second reagent can be drawn through one or more of the second ends and into one or more of the respective capillary tubes. In some exemplary embodiments, the loading tray and/or the second container can comprise a multi-well plate having multiple wells. The multiple wells of the multi-well plate can comprise wells that contain the second reagent and wells that do not contain the second reagent. The method can comprise reacting the second reagent with the first activated sequence to form a first sequence.

In various embodiments, the array of capillary tubes can be filled with washing and/or other neutral solutions. The washing and/or other neutral solutions can fill the array of capillary tubes by dipping the capillary ends into a container having the washing and/or other neutral solutions. The container having the washing and/or other neutral solutions can be located either near the end of the array of capillary tubes proximate to the pressure control source or can be located near the end of the array of capillary tubes proximate to the reagent container support. In some exemplary embodiments, wherein the washing and/or other neutral solutions can be located near the end of the array of capillary tubes proximate to the pressure control source, the washing and/or other neutral solutions can be placed in fluid communication with the capillary tubes and positive pressure can be applied by the pressure control source to fill the array of capillary tubes with the washing and/or other neutral solutions. In some exemplary embodiments, the capillary ends near the reagent container support can be positioned next to a waste reservoir. The waste reservoir can be located on the reagent container support. The waste reservoir can contain the washing solution in the array of capillary tubes. In some exemplary embodiments, wherein the washing solution is located near the end of the array of capillary tubes proximate to the reagent container support, the array of capillary tubes can be placed in fluid communication with the solution and the reservoir control source can create a vacuum, suction, or negative pressure in one or more of the capillary tubes to inject the washing solution into one or more of the capillary tubes. A waste reservoir can be placed at the end of the capillary tubes near/in communication with the pressure control source to remove any excess washing solution from the capillary tubes.

In various embodiments, a reagent can be disposed in fluid communication with the array of capillary tubes. In some exemplary embodiments, one or more of the capillary tubes can be moved into or out of a fluid comprising the reagent when a capillary is moved out, fluid communication can be interrupted when a capillary is moved into the fluid, communication can be established. The fluid communication interruption can also be caused by computer control valves, valves, or other means known in the art. Depending on the position of the reagent, the reagent can be injected into the capillary tubes via negative or positive pressure. For example, if the reagent is positioned near the end of the array of capillary tubes proximate to the reagent container support, then the pressure control source can create a negative pressure to inject the reagent into the array of capillary tubes. In some exemplary embodiments, wherein the reagent is located near the end of the array of capillary tubes proximate to the pressure control source, the pressure control source can provide a positive pressure to inject the reagent into the array of capillary tubes. The entire inner surface area or at least a portion of the inner surface area of the array of capillary tubes can come in contact with the reagent. The portion of the capillary tubes in contact with the reagent can depend on the injection time. The inner surface area of the array of capillary tubes where oligonucleotide synthesis takes place can be determined by a quantity or volume of the first reagent that can fill the array of capillary tubes. In some exemplary embodiments, the washing and reaction steps can be repeated with different reaction reagents as required by the synthesis protocol.

In various embodiments, the first container can comprise a first multi-well plate. The second container, if any, can comprise a second multi-well plate that can be different from the first multi-well plate. At least one of the wells in the first multi-well plate can comprise a reagent, for example, a deprotectant that can be introduced into the array of capillary tubes. As described earlier, the linker can comprise a protected oligonucleotide. The protected oligonucleotide of the linker can be deprotected by introducing a deprotectant into the array of capillary tubes. In some exemplary embodiments, the second reagent can comprise a protected nucleotide.

As discussed above, a nucleotide can be added after a washing step. Each nucleotide added in the synthesis can be protected. The added nucleotide can be protected by any protecting group. Some exemplary suitable protecting groups can be labile groups, including acyl groups, for example, acetyl, benzoyl, isobutyryl, or phenoxyacetyl groups and amidine groups, for example, formamidine or dimethylamidine. Other examples can comprise dimethoxytrityl (DMT) group. In some examples, the exocyclic amino groups on the purine and pyrimidine bases of the nucleotides can be protected, as amides, throughout the sequence, according to well established methods (Gait, 1990).

The protecting groups can be removed and converted to soluble derivatives such as amides by the use of anhydrous amines. In this form, the removed organic groups can generally be soluble in the amine reagent. The removal of the amine reagent can therefore serve to remove these amides upon completion of the library synthesis. As the coupling reactions can be sensitive to air and moisture, they can be carried out in an inert atmosphere. Other deprotecting agents can comprise an active methylene compound and an amine agent. The active methylene compound can have the structure:

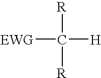

The substituent EWG can be an electron-withdrawing group comprising nitro, ketone, ester, carboxylic acid, nitrile, sulfone, sulfonate, sulfoxide, phosphate, phosphonate, nitroxide, nitroso, trifluoromethyl, and aryl groups substituted with one or more nitro, ketone, ester, carboxylic acid, nitrile, sulfone, sulfonate, sulfoxide, phosphate, phosphonate, nitroxide, nitroso, and trifluoromethyl. The substituent R can comprise hydrogen, C₁-C₁₂ alkyl, C₆-C₂₀ aryl, heterocycle, and an electron-withdrawing group. The amine reagent can be aqueous ammonium hydroxide, aqueous methylamine, or anhydrous C₁-C₆ alkylamine. In other embodiments, the deprotection reagent can comprise water or an alcohol solvent. Protecting groups can be removed from an oligonucleotide by treatment with a deprotection reagent.

In some embodiments, the method to deprotect an oligonucleotide can comprise wetting the protected oligonucleotide covalently attached to an inner surface of a capillary tube with an active methylene compound and a solvent. The protected oligonucleotide can then be reacted with an amine reagent. The amine reagent can be in a liquid or gas phase; aqueous or anhydrous, e.g. aqueous ammonium hydroxide, ammonia gas, or a C₁-C₆ alkylamine.

In various embodiments, the first sequence can comprise an oligonucleotide, a ribonucleic acid, a deoxyribonucleic acid, and/or a peptide sequence.

In various embodiments, any excess reagents, for example, an excess second reagent, can be removed or discharged from a capillary tube into a waste reservoir. A capillary tube can be adapted to be in fluid communication with the third reagent. In some embodiments, a robot arm can be utilized to move a capillary tube or an array of capillary tubes in fluid communication with a third reagent. The pressure control source can create a negative pressure to draw the third reagent through one or more of the capillary endings and into one or more of the array of capillary tubes. The third reagent that is drawn into the array of capillary tubes can comprise a deprotectant. The third reagent can react with the first sequence to form a second activated sequence. The excess third reagent can be removed from one or more of the array of capillary tubes into a waste reservoir.

In various embodiments, the array of capillary tubes can be moved and placed in fluid communication with a fourth reagent, which can be in a loading tray or a fourth container. The fourth reagent can be loaded or drawn through one or more of the array of capillary endings proximate to the reagent container support, and into one or more of the respective array of capillary tubes. The fourth reagent can react with a second activated sequence. The fourth reagent can comprise a protected nucleotide.

In various embodiments, the array of capillary tubes can be divided into a first subset of the array of capillary tubes, and a second subset of the array of capillary tubes. The second subset of the array of capillary tubes can at least partially differ from the first subset. In one example, the ends of the second subset near the reagent container support can be moved so that the ends are in fluid communication with a reagent, whereas the first subset of the array of capillary tubes can be positioned so that the ends of the first subset are not in a fluid communication with the reagent. For example, the first subset of the array of the capillary tubes can be in an “up” position relative to the reagent container support so that the ends of the first subset of the capillary tubes are not dipped into the wells containing the reagent. Alternatively, the ends of the first subset of the capillary tubes can be lowered with the ends of the second subset of the capillary tubes. In other embodiments, the wells corresponding to the ends of the first subset of the array of capillary tubes can not contain any reagents. In some embodiments, a count of wells in the multi-well plate can be the same as a count of capillary tubes in the array of capillary tubes. In some embodiments, the third reagent can be drawn through the ends of the second subset and into the second subset of the array of capillary tubes. The third reagent can react with at least one of the linkers or the first sequence to form an activated sequence in the second subset of the array of capillary tubes. In some exemplary embodiments, the method can comprise drawing different reagents into one or more of the individual capillary tubes of the second subset of the array of capillary tubes to form different sequences in one or more of the second subset of the array of capillary tubes.

In various embodiments, the method can comprise cleaving the first sequence, a derivative thereof, or the oligonucleotide from the inner surface wall of the array of capillary tubes.

Cleavage of the oligonucleotide (20 μmole to 1 nmole) from the inner walls of the array of capillary tubes can be performed in the capillary tubes at a room temperature using from about 1 to about 3 ml concentrated ammonium hydroxide NH₄OH (about 28-30% NH₃ in water). Cleavage of the typical ester linkage of the oligonucleotide can be completed in about one hour under these conditions. While the linkage between the oligonucleotide and the inner surface walls of the capillary tubes is cleaving, ammonium hydroxide can also remove the 2-cyanoethyl groups from the internucleotide phosphates and the nucleobase protecting groups. Depending on the nucleobase and the type of protecting group, deprotection (removal of protecting group) of the oligonucleotide can require approximately 1 to 8 hours at 55° C. treatment with a concentrated ammonium hydroxide.

In other embodiments, cleavage and deprotection can be conducted with anhydrous amines (U.S. Pat. No. 5,750,672), methylamine (U.S. Pat. Nos. 5,348,868 and 5,518,651), hydrazine and ethanolamine (Polushin (1991) Nucleic Acids Res. Symposium Series No. 24, p. 49-50; Polushin (1994) Nucleic Acids Res. 22:639-45), all of which are incorporated in their entirety herein. In the event that one or more of the incorporated literature and similar materials differs from or contradicts this application, including but not limited to defined terms, terms usage, described techniques, or the like, this application controls. Additionally, other known cleaving methods can be utilized to cleave the oligonucleotides of the present teachings.

Exemplary devices and methods according to various embodiments are described below with reference to the drawings. The present teachings are not limited to the embodiments depicted in the drawings.

Referring to FIG. 1, a schematic of a system 100 that utilizes an inner surface of a capillary tube 20 to perform an oligonucleotide synthesis is illustrated. Any number of capillary tubes 20 and/or wells can be used. For example, system 100 can comprise 4, 12, 24, 48, 96, 192, 384, or more capillary tubes 20. In an exemplary embodiment, depicted in FIG. 1, system 100 comprises an array of 12 capillary tubes 20 corresponding to 12 wells disposed in a loading tray 54. Capillary tubes 20 can comprise first ends 22 and second ends 24 as seen in FIG. 2. A pressure control source 26 can be in communication with first ends 22, for example, all first ends 22. A first interface 32 can be arranged to hold the capillary tubes 20 operatively within pressure control source 26. A second interface 34, also known as a capillary array head/template 34, can be supported by a second interface support 35, also known as a capillary array head/template support 35. Second interface 34 can hold second ends 24 of capillary tubes 20.

FIG. 2 is an enlargement of first interface 32 with respect to capillary tubes 20, second interface 34, and second endings 24. Second interface 34 can comprise a plurality of boxes 33.

In an exemplary embodiment shown in FIGS. 1, 2, and 3, twelve blocks 33 are depicted. It is to be understood that the system of the present teachings can include any number of blocks, for example, 24, 96, 384, or more. In some embodiments, a count of blocks can equal a count of capillary tubes 20. A capillary tube 20 can correspond to a respective block 33. When second interface 34, as illustrated in FIG. 1, comprises twelve blocks 33, a respective capillary tube 20 can correspond to a respective block 33. In some exemplary embodiments, each of the individual blocks 33 can be capable of moving independently when block 33 moves, block 33 can move respective to capillary tube 33. In some exemplary embodiments, as depicted in FIG. 3, second ends 24 of capillary tubes 20 can extend beyond second interface 34 by at least about 0.1 cm, for example, about 0.5 cm.

In various embodiments, system 100 of the present teachings can comprise a reagent container support. The reagent container support can comprise platen 28. Platen 28 can be in any geometric shape, for example, round, as depicted in FIG. 1. Platen 28 can be capable of rotating around an axis of rotation. System 100 can optionally comprise waste reservoir 55 and/or reagent containers 30 that can be disposed on the platen 28, as illustrated in FIG. 1.

In various embodiments, containers 30 can contain a desired chemical base, deprotectant, and/or waste. In one example, as illustrated in FIG. 1, at least one container 30 can comprise a nucleotide. For example, containers 30 can comprise a reagent container 38. Reagent containers 38 can contain protected cytosine. A reagent container 40 can contain protected guanine. A reagent container 42 can contain protected adenine. A reagent container 44 can contain protected thymine. In some exemplary embodiments, containers 38, 40, 42, and 44 can contain cytosine (C), guanine (G), adenine (A), and thymine (T), respectively, without their protector. In some exemplary embodiments, wherein the containers 38, 40, 42, and 44 comprise a nucleotide without a protector, system 100 can comprise a separate container (not shown) containing a protector to protect one or more of the nucleotides in capillary tubes 20, when necessary. In addition to containers 38, 40, 42, and 44, containers 30 can comprise a container 56 that can contain a deprotector to deprotect one or more of the protected nucleotides. A container 46 can contain a washing solution, such as, for example, acetonitrile. A container 59 can contain a cleaving solution to cleave a completed synthesized oligonucleotide.

In various embodiments, system 100 can comprise loading tray 54. Contents of any of the containers 38, 40, 42, 44, 46, 56, or 59 can be loaded in loading tray 54. Contents of any of the containers 38, 40, 42, 44, 46, 56, or 59 can be injected into capillary tubes 20 by dipping second ends 24 of capillary tubes 20 into wells 66 of loading tray 54. The contents in containers 38, 40, 42, 44, 46, 56, and 59 can be loaded into loading tray 54 using a dispensing block 36. As shown in FIG. 1, in some exemplary embodiments, container 56 can contain a deprotector disposed at a loading station position 57. Dispensing heads 39 can be disposed in dispensing block 36, which can be in communication with a pressure control unit 37. Dispensing tips can be configured to match placement of wells in containers 30. Pressure control unit 37 can be adapted to allow dispensing heads 39 to uptake a predetermined amount of reagent from container 30 in communication with dispensing heads 39. Pressure control unit 33 can eject any reagents from the dispensing heads 39 into corresponding wells of loading tray 54, into waste reservoir 55, or other containers 30. Container 56 containing a deprotector can be placed at loading station position 57 for dispensing heads 39 to fluidically communicate with container 56 to uptake or aspirate a predetermined amount of a deprotector. In other embodiments, loading tray 54 can be placed at loading station position 57 to load loading tray 54 with a deprotector aspirated into dispensing heads 39. Loading tray 54 can be placed in fluid communication with capillary ends 24 of capillary tubes 20 to allow pressure control unit 26 to inject the deprotectant dispensed to loading tray 54 into capillary tubes 20.

In the embodiment shown in FIG. 1, in order to move second ends 24 of capillary tubes 20 to be in communication with loading tray 54, capillary tubes 20 can be held in a precise pattern by threading capillary tubes 20 through second interface 34. In the embodiment shown in FIG. 1, second interface 34 can move in directions transverse to platen 28, for example, directions 27. This movement can move capillary tubes 20 in to a down or load position (see, for example, in FIG. 1 lower second interface 34), such that second ends 24 of capillary tubes 20 can be in communication with the loading tray 54, or in a clear position (see, for example, in FIG. 1 the upper second interface 34), such that second ends 34 of capillary tubes 20 are not in communication with loading tray 54.

In various embodiments, second interface 34 can comprise blocks 33 that can move independent from one another. In some embodiments, each of the blocks 33 can independently move their corresponding capillary tube 20 to a down or clear position such that only a desired capillary tube is in fluid communication with loading tray 54.

In some embodiments, in order to move second ends 24 of capillary tubes 20 to be in fluid communication with loading tray 54, for example, to allow pressure control source 26 to inject a deprotector into capillary tubes 20, capillary tubes 20 can be affixed to a robot arm (not shown in the figures). In various embodiments, capillary tubes 20 can be held in a precise pattern by threading capillary tubes 20 through second interface 34. Second interface 34 can slidably hold each of the capillary tubes 20. In some exemplary embodiments, second interface 34 can allow one or more of second ends 24 of capillary tubes 20 to move with respect to an attachment site (not shown in the figures) that can hold capillary tubes 20 at a point spaced from second ends 24 of capillary tubes 20. In some exemplary embodiments, the robot arm can move in at least three axis, for example, X, Y, and Z, to place second ends 24 of capillary tubes 20 in direct communication with loading tray 54.

In some exemplary embodiments, system 100 can comprise container 46 that has a washing solution. After each reaction step, dispensing heads 39 can be washed by placing the container 46, having the washing solution, at loading station position 57 so that container 46 can be in fluid communication with dispensing heads 39.

In various embodiments, system 100 of the present teachings can not include a dispensing block. In this system, the containers 38, 40, 42, 44, 46, 56, and 59 can act as individual loading trays that can be placed in communication with second ends 24 of capillary tubes 20. In some exemplary embodiments, after each reaction step, excess reagents can be discarded in waste reservoir 55 and, optionally, capillary tubes 20 can be washed using the washing solution in container 46. When platen 28 can be rotatable, a control device (not shown) can control a drive unit (not shown) to move a desired container 30 to a desired position.

Referring to FIG. 4, in various embodiments, the method of the present teachings can comprise providing, in capillary tubes 20, linkers 48 attached to an inner wall surface 21. According to FIG. 4, linkers 48 are activated or deprotected so that a nucleotide can be attached to one or more of the linkers 48. One or more of the second ends 24 can be moved into communication with loading tray 54 providing a first reagent. For example, container 40 can contain a reagent comprising protected guanine. Container 40 can be brought into communication with dispensing block 36 by placing container 40 at loading station position 57. Using dispensing heads 39 in combination with pressure unit 37, a predetermined amount of the protected guanine reagent can be aspirated or loaded into one or more dispensing heads 39. In some embodiments, loading tray 54 can then be placed at loading station position 57, allowing loading tray 54 to be in communication with one or more dispensing heads 39 having the protected guanine reagent loaded therein. Pressure unit 37 can inject the protected guanine reagent from one or more dispensing heads 39 into loading tray 54.

In some embodiments, loading tray 54 can be positioned such that second ends 24 can be brought into communication with loading tray 54 containing the protected guanine reagent. Pressure control source 26 can be in communication with first ends 22 of capillary tubes 20. Pressure control source 26 can provide a pressure differential to one or more capillary tubes 20 to load the protected guanine reagent into one or more capillary tubes 20.

As shown in FIG. 5, guanine nucleotides 50 comprising a protector 52 can react with one or more linkers 48 to form a sequence. Any excess protected guanine reagent can be disposed of in waste reservoir 55 using, for example, pressure control source 26. Optionally, after each reaction step, dispensing heads 39 and/or dispensing block 36 can be washed using the washing solution, for example, acetonitrile in container 46. To wash dispensing heads 39 and/or dispensing block 36, container 46 can be placed at loading station position 57. Dispensing heads 39 can be brought into communication with container 46 containing the washing solution. Pressure unit 37 can load the washing solution into dispensing heads 39 to wash dispensing heads 39 and/or dispensing block 36. Waste reservoir 55 can be brought into communication with dispensing heads 39 so that any excess washing solution in dispensing block 36 and/or dispensing heads 39 can be discharged into waste reservoir 55.

In various embodiments, a second reagent can be added to capillary tubes 20 by bringing second ends 24 of capillary tubes 20 into communication with loading tray 54 containing the second reagent. In some embodiments the second reagent can be a deprotector. The container 56 can be brought into communication with dispensing block 36. Pressure unit 37 can inject a predetermined amount of the second reagent into dispensing heads 39. Loading tray 54 can be placed at loading station position 57 such that loading tray 54 can be in communication with dispensing heads 39, presently loaded with the deprotector. Pressure unit 37 can inject the second request from dispensing head 39 into loading tray 54. In some embodiments, each dispensing head 39 can correspond to a well in loading tray 54. Loading tray 54 can be positioned such that second ends 24 can be brought into communication with loading tray 54 containing the second reagent or deprotectant (see, for example, FIG. 1).

In some embodiments, each second end 24 can correspond to a well in loading tray 54. Pressure control source 26 can be in communication with first ends 22. Pressure control source 26 can provide a pressure differential to one or more of capillary tubes 20 to load the deprotectant from loading tray 54 into capillary tubes 20. The deprotector in container 56 can react with one or more of the nucleotides, such as guanine nucleotides 50 comprising protector 52, to remove protector 52 from the nucleotide.

As illustrated in FIG. 6, once the deprotectant has reacted with protector 52, a remaining sequence can comprise linker 48 and guanine nucleotides 50, now activated. Any excess deprotectant reagent can be disposed of in waste reservoir 54 (FIG. 1). As stated earlier, dispensing block 36 and/or dispensing heads 39 can be washed using the washing solution, for example, acetonitrile in container 46.

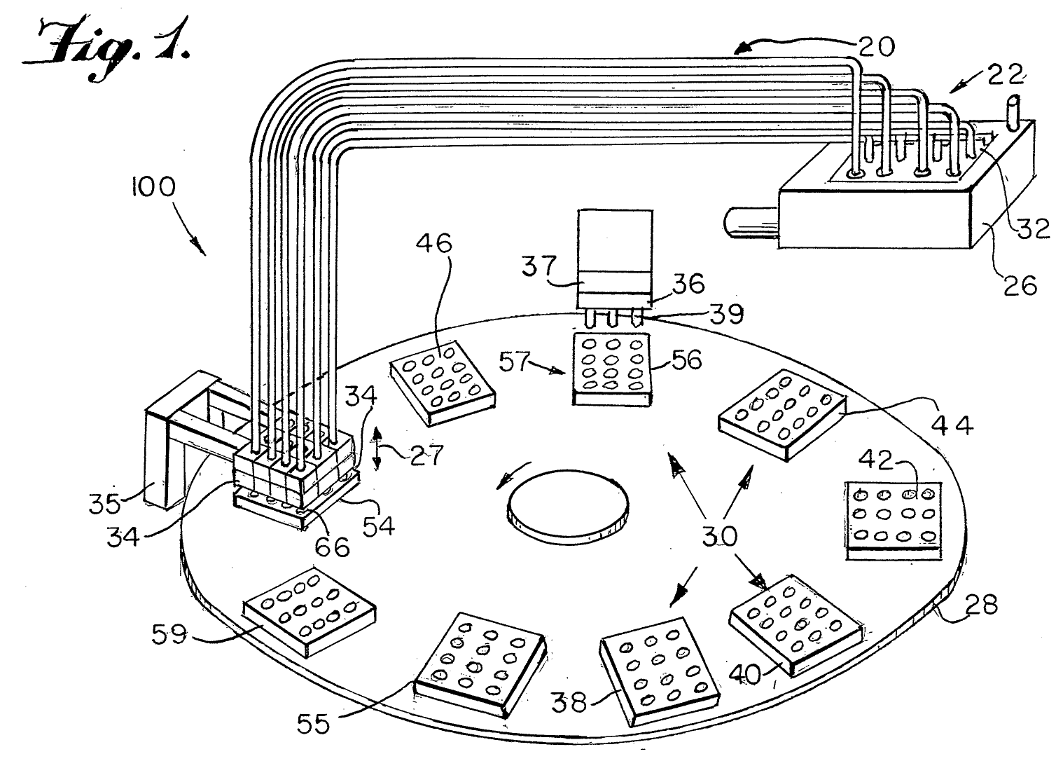

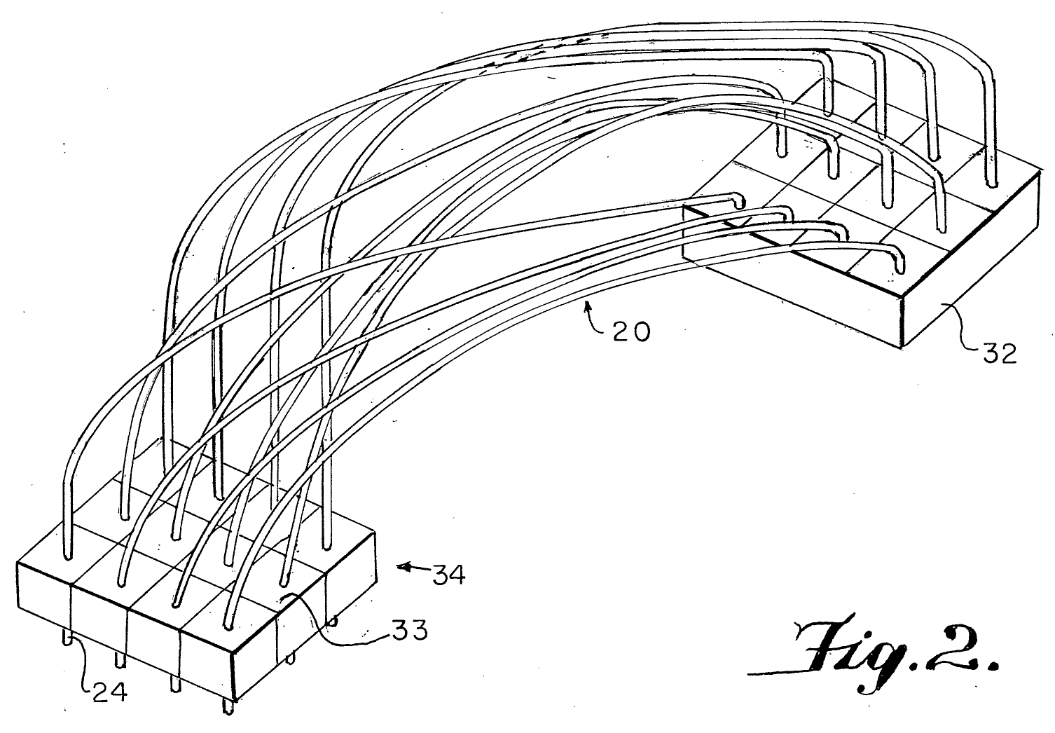

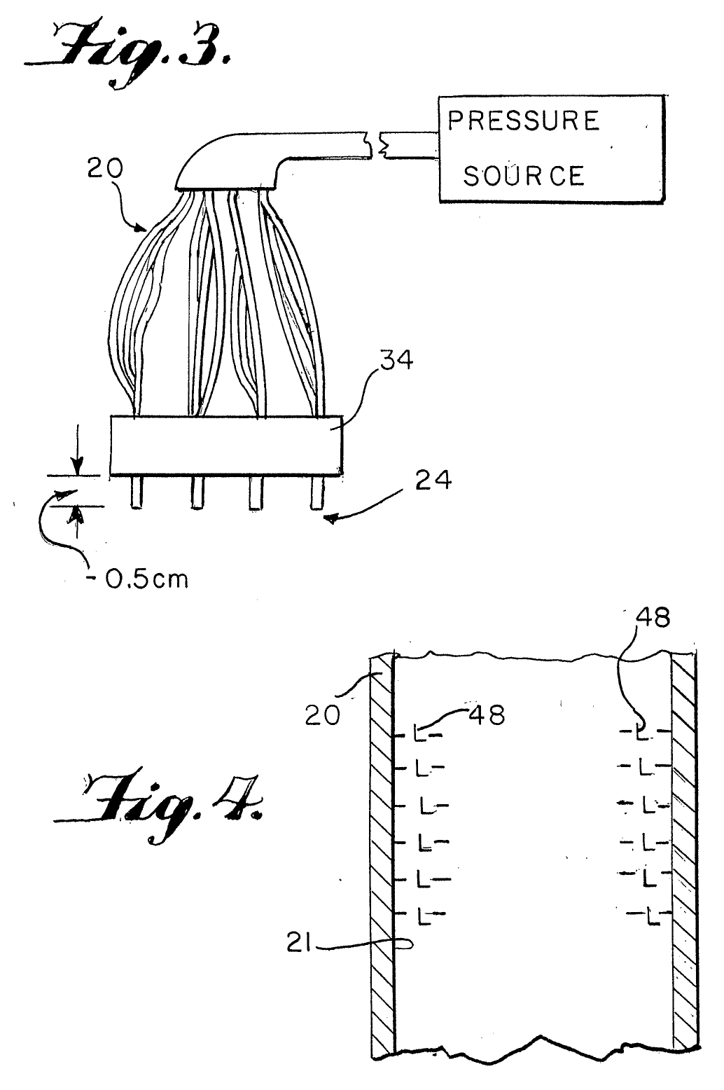

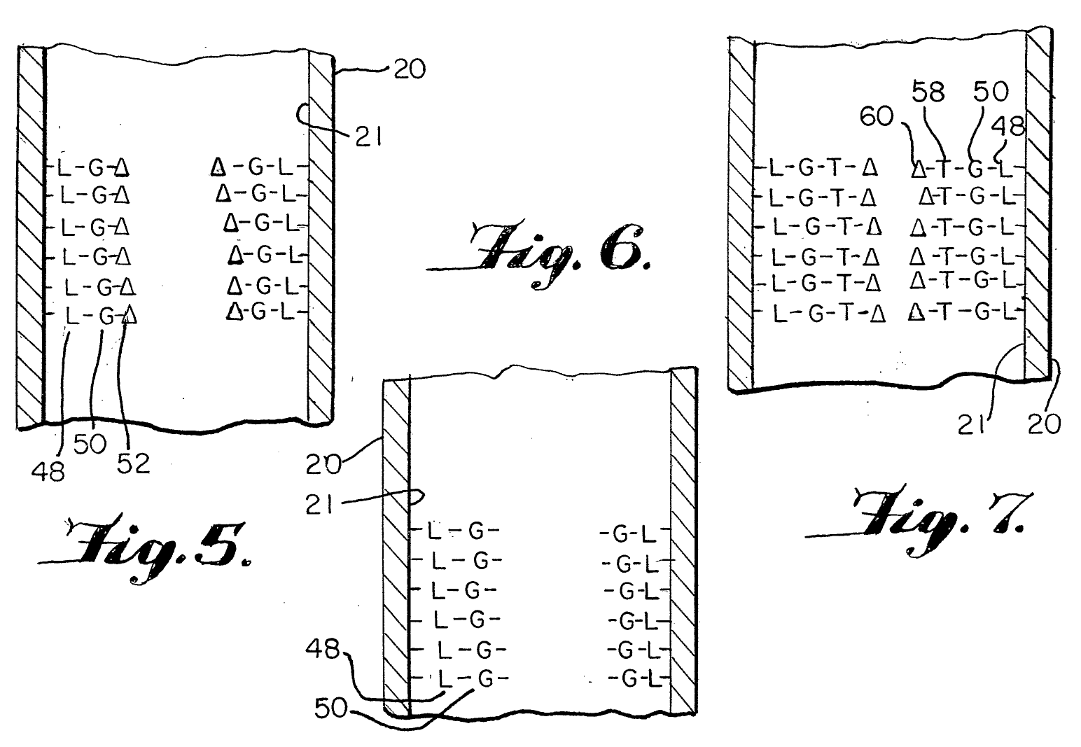

In various embodiments, a third reagent can be added to capillary tubes 20 by bringing second ends 24 into communication with loading tray 54 containing a third reagent. In some embodiments, for example, the third reagent can comprise a protected thymine. Container 44 can be placed at loading station position 57 and in communication with dispensing heads 39. A predetermined amount of the protected thymine reagent can be injected into dispensing heads 39. Platen 28 can be positioned to place loading tray 54 at loading station position 57 and pressure unit 37 can inject the protected thymine reagent from dispensing heads 39 into loading tray 54. Platen 28 can place loading tray 54 in a position such that second ends 24 can be brought into communication with loading tray 54 containing the protected thymine. The protector of the thymine can be the same type of protector as protector 52 of guanine 50, (see FIG. 5) or the thymine nucleotide 58 can have a different protector, for example, protector 60, as indicated in FIG. 7. Pressure control source 26 can provide a pressure differential to one or more capillary tubes 20 to load or inject the protected thymine reagent into capillary tubes 20. As shown in FIG. 7, the thymine nucleotides 58 having protector 60 can react with one or more of the activated guanine nucleotides 50 to form sequence L-G-T-Δ. Any excess protected thymine can be disposed of in waste reservoir 55. As stated earlier, optionally, the dispensing heads 39 and/or the dispensing block 36 can be washed using the washing solution in the container 46, such as, for example, acetonitrile.

In various embodiments, the linkers, instead of being activated, can comprise a protector. In some exemplary embodiments, the first reagent can be a deprotector to deprotect and/or activate the linkers. Any excess deprotector can be discarded and the capillary tubes can optionally be washed using a washing solution. Once the linkers have been activated, a nucleotide can react with the activated linkers, as described above, to form a desired sequence.

In various embodiments, capillary tubes 20 can comprise at least a first subset of capillary tubes 20 and a second subset of capillary tubes 20. Having different subsets of capillary tubes 20 can allow synthesis of different oligonucleotides on the inner wall of the subsets, in one set of capillary tubes 20.

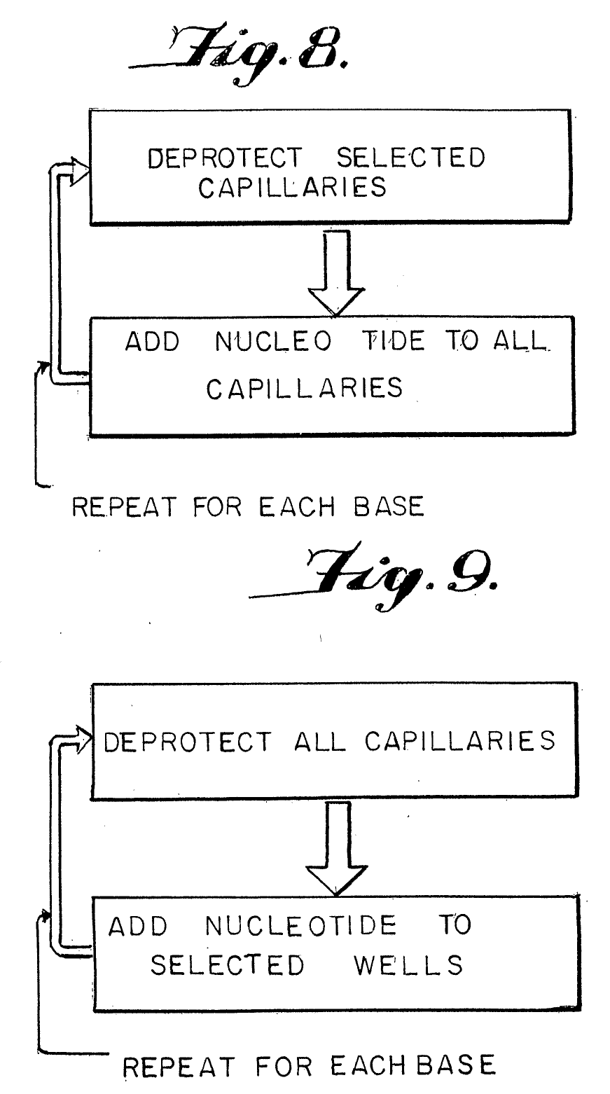

Different methods can be used to synthesize different oligonucleotides in different subsets of capillary tubes 20. One such method is exemplified in FIG. 8. The first subset of capillary tubes 20 can comprise linkers or nucleotides that can comprise a protector, whereas the second subset of capillary tubes 20 can comprise linkers or nucleotides that are activated, not having a protector. A nucleotide can be added to both the first and second subsets of capillary tubes 20. The added nucleotide can react with the activated linkers or nucleotides, but not with the linkers or nucleotides that have a protector. A pre-selected or desired number of subsets of capillary tubes 20 can be deprotected and the process can be repeated for each nucleotide base until the desired oligonucleotides have been synthesized in each of the subsets of capillary tubes 20.

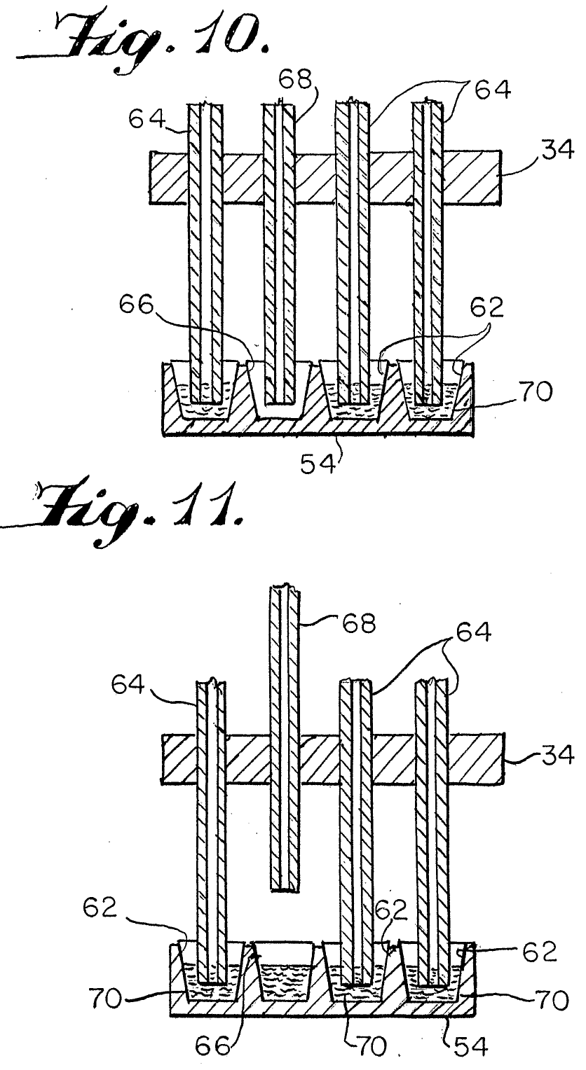

In various embodiments, a method to synthesize different oligonucleotides in different subsets of capillary tubes 20 is exemplified in FIG. 9. According to FIG. 9, the linkers or the nucleotides in both the first and second subsets of capillary tubes 20 can be deprotected so that the linkers or the nucleotides are activated. However, in some embodiments, only a pre-selected number of wells in the loading tray 54 can comprise a nucleotide. A first subset 68 of capillary tubes 20 and a second subset 64 of capillary tubes 20 can be brought in communication with a first subset of wells 66 and a second subset of wells 62, respectively. Reagents comprising nucleotides can be present in wells of loading tray 54. Reagents can be injected into their corresponding capillary tube in the capillary tubes 20. For example, as illustrated in FIG. 10, the second subset of wells 62 in loading tray 54, can correspond to second subset 64 of capillary tubes 20 that can contain a nucleotide reagent 70, whereas, the second subset of wells 66, in loading tray 54 can correspond to the first subset 68 of capillary tube 20, that may not contain any nucleotide reagent. A sequence synthesized in second subset 64 of capillary tubes 20 can react with added nucleotide reagents 70.

In various embodiments, as exemplified in FIG. 11, a method to synthesize different oligonucleotides in different subsets of the array of capillary tubes 20 is illustrated. According to FIG. 11, the linkers and/or the nucleotides in both the first subset 68 and second subset 64 of capillary tubes 20 can be deprotected so that the linkers and/or the nucleotides are activated. As illustrated in FIG. 11, wells 66 and 62, in loading tray 54, (wells corresponding to both the first subset 68 and second subset 64 of capillary tubes 20) can comprise a nucleotide reagent 70. In operation, if desired, only second subset 64 of capillary tubes 20 can be brought into communication with nucleotide reagent 70. In some exemplary embodiments, first subset 68 of capillary tubes 20 can avoid being brought into communication with nucleotide reagent 70. Therefore, nucleotide reagent 70 in wells 66 of loading tray 54 cannot be injected into the first subset 68 of capillary tubes 20. This process can be repeated until a desired synthesized oligonucleotide is created in both the first subset 68 and second subset 64 of capillary tubes 20.

According to some embodiments, the method of synthesizing can use a control computer (not shown) that can integrate the operation of the various system control assemblies, for example, the platen, the pressure control block, the dispensing head, the second interface, or the first interface. The control can be implemented through a program written in an event driven language such as LABVIEW® or LABWINDOWS® (National Instruments Corp., Austin, Tex.). In particular, the LABVIEW® software provides a high level graphical programming environment for controlling instruments. U.S. Pat. Nos. 4,901,221; 4,914,568; 5,291,587; 5,301,301; 5,301,336; and 5,481,741, each expressly incorporated herein in its entirety by reference, disclose various aspects of the LABVIEW graphical programming and development system. The graphical programming environment disclosed in these patents allows a user to define programs or routines by block diagrams, or “virtual instruments.” As this is done, machine language instructions are automatically constructed which characterize an execution procedure corresponding to the displayed procedure. Interface cards for communicating the computer with the motor controllers are also available commercially, for example, from National Instruments Corp.

Those skilled in the art can appreciate from the foregoing description that the present teachings can be implemented in a variety of forms. Therefore, while these teachings have been described in connection with particular embodiments and examples thereof, the true scope of the present teachings should not be so limited. Various changes and modifications can be made without departing from the scope of the teachings herein.

What is claimed:

1. A system comprising:
an array of capillary tubes, each capillary tube in the array of capillary tubes comprising a first end, a second end, an inner wall, and a sequence linker bonded to the inner wall;
a pressure control source in fluid communication with each of the first ends; and
a reagent container support;
wherein the second end of each capillary tube is adapted to individually move towards and away from the reagent container support.

2. The system of claim 1, further comprising at least one of a waste reservoir or reagent container in fluid communication with at least one of the first ends.

3. The system of claim 1, further comprising a first interface arranged to hold the array of capillary tubes operatively within the pressure control source.

4. The system of claim 1, wherein the pressure control source comprises a pressure control block.

5. The system of claim 1, further comprising a microfluidic device located proximate the second ends of the array of capillary tubes.

6. The system of claim 5, further comprising a second interface arranged to hold the second ends of the capillary tubes in the microfluidic device.

7. The system of claim 6, wherein the second ends of the array of capillary tubes pass through and extend beyond the second interface by at least about 0.1 cm.

8. The system of claim 1, further comprising a reagent container supported by the reagent container support, wherein the reagent container comprises at least one multi-well plate comprising a plurality of wells.

9. The system of claim 8, further comprising at least one dispensing unit adapted to at least partially fill at least one of the plurality of wells with one or more reagents.

10. The system of claim 1, further comprising a cleaving reagent adapted to be in fluid communication with at least one of the first ends.

11. The system of claim 1, wherein the reagent container support further comprises a rotating platen adapted to support a plurality of reagent plates.

12. The system of claim 1, wherein the pressure control source 15 is capable of providing a positive pressure and a negative pressure individually to each capillary tube.

13. The system of claim 1, wherein the array of capillary tubes comprises 24 or more capillary tubes.

14. A system comprising:
an array of capillary tubes, each capillary tube comprising a first end, a second end, and an inner wall;
a pressure control source in fluid communication with each of the first ends; and
a reagent container support comprising a rotating platen adapted to hold a plurality of reagent containers;
wherein the second end of each capillary tube is adapted to individually move toward and away from the reagent container support.

15. The system of claim 14, further comprising at least one of a waste reservoir or a reagent container in fluid communication with at least one of the first ends.

16. The system of claim 14, further comprising a first interface arranged to hold the array of capillary tubes operatively within the pressure control source.

17. The system of claim 14, wherein the pressure control source comprises a pressure control block.

18. The system of claim 14, further comprising a microfluidic device located proximate the second ends of the array of capillary tubes.

19. The system of claim 18, further comprising a second interface arranged to hold the second ends of the capillary tubes in the microfluidic device.

20. The system of claim 19, wherein the second ends of the array of capillary tubes pass through and extend beyond the second interface by at least about 0.1 cm.

21. The system of claim 14, further comprising a reagent container supported by the reagent container support, wherein the reagent container comprises at least one multi-well plate comprising a plurality of wells.

22. The system of claim 21, further comprising at least one dispensing unit adapted to at least partially fill at least one of the plurality of wells with one or more reagents.

23. The system of claim 14, further comprising a cleaving reagent adapted to be in fluid communication with at least one of the first ends.

24. The system of claim 14, wherein the pressure control source is capable of providing a positive pressure and a negative pressure individually to each capillary tube.

25. The system of claim 1, wherein said sequence linker is a nucleotide linker.

26. The system of claim 1, wherein said sequence linker is an amino acid linker.

27. The system of claim 1, wherein the linker comprises a protected oligonucleotide.

28. The system of claim 1, wherein the first reagent comprises a deprotectant.

29. The system of claim 1, wherein the second reagent comprises a protected nucleotide.

30. The system of claim 1, wherein the first sequence comprises an oligonucleotide.

31. The system of claim 1, wherein the first sequence comprises a ribonucleic acid sequence.

32. The system of claim 1, wherein the first sequence comprises a deoxyribonucleic acid sequence.

33. The system of claim 1, wherein the first sequence comprises a peptide sequence.

34. A method comprising:
providing an array of capillary tubes, each capillary tube including a first end, a second end, an inner wall, and a linker bonded to the inner wall;
connecting a pressure control source to the first ends, wherein the pressure control source is capable of providing a pressure differential to each of the capillary tubes;
moving one or more of the second ends into communication with a first reagent in a first container;
drawing the first reagent through the one or more second ends into the one or more respective capillary tubes;
reacting the first reagent with the linker in the one or more respective capillary tubes to form a first activated sequence;
removing excess first reagent from the one or more respective capillary tubes;
moving the one or more second ends into communication with a second reagent in a second container;
drawing the second reagent through the one or more second ends and into the one or more respective capillary tubes; and
reacting the second reagent with the first activated sequence to form a first sequence.

35. The method of claim 34, wherein the first container comprises a first multi-well plate.

36. The method of claim 35, wherein the second container comprises a second multi-well plate that differs from the first multi-well plate.

37. The method of claim 34, wherein the linker comprises a protected oligonucleotide.

38. The method of claim 34, wherein the first reagent comprises a deprotectant.

39. The method of claim 34, wherein the second reagent comprises a protected nucleotide.

40. The method of claim 34, wherein the first sequence comprises an oligonucleotide.

41. The method of claim 34, wherein the first sequence comprises a ribonucleic acid sequence.

42. The method of claim 34, wherein the first sequence comprises a deoxyribonucleic acid sequence.

43. The method of claim 34, wherein the first sequence comprises a peptide sequence.

44. The method of claim 34, further comprising removing excess second reagent from the one or more capillary tubes.

45. The method of claim 44, further comprising moving the one or more second ends into communication with a third reagent in a third container;
drawing the third reagent through the one or more second ends and into the one or more respective capillary tubes; and
reacting the third reagent with the first sequence.

46. The method of claim 45, wherein the third reagent comprises a deprotectant and reacting the third reagent with the first sequence forms a second activated sequence.

47. The method of claim 46, further comprising removing excess third reagent from the one or more capillary tubes.

48. The method of claim 47, further comprising moving the one or more second ends into communication with a fourth reagent in a fourth container;
drawing the fourth reagent through the one or more second ends and into the one or more respective capillary tubes; and
reacting the fourth reagent with the second activated sequence.

49. The method of claim 48, wherein the fourth reagent comprises a protected nucleotide.

50. The method of claim 34, wherein the array of capillary tubes comprises a first subset and a second subset, and the method further comprises moving the second ends of the second subset into communication with a third reagent in a third container, wherein the second subset at least partially differs from the first subset;
drawing the third reagent through the second ends of the second subset and into the second subset of capillary tubes; and
reacting the third reagent with at least one of the linker or the first sequence to form an activated sequence in the second subset of the array of capillary tubes.

51. The method of claim 50, comprising drawing different reagents into different ones of the second subset of capillary tubes to form different sequences in the different ones of the second subset of capillary tubes.

52. The method of claim 34, wherein the second container comprises a multi-well plate, that comprises at least one first well that contains the second reagent and at least one well that does not contain the second reagent.

53. The method of claim 52, wherein a count of wells in the multi-well plate equals a count of capillary tubes in the array of capillary tubes.

54. The method of claim 34, further comprising cleaving the first sequence or a derivative thereof, from the inner wall.

55. The method of claim 34, wherein the pressure control source comprises a pressure control block.

56. A method comprising:
loading a first reagent into an array of capillaries, each capillary comprising an inner wall and a linker bonded to the inner wall;
reacting the first reagent with the linker to form an activated sequence;
loading a second reagent into the array of capillaries; and
reacting the first activated sequence to form a first sequence.
